(19) United States
(12) Patent Application Publication
(10) Pub. No.: US 2020/0261755 A1
(43) Pub. Date: Aug. 20, 2020

(54) FIRE CONTROL SYSTEM

(71) Applicant: Adaptafire International Pty Ltd, New South Wales (AU)

(72) Inventor: Elias Salim Hajjar, New South Wales (AU)

(21) Appl. No.: 16/061,550

(22) PCT Filed: Nov. 18, 2016
(86) PCT No.: PCT/AU2016/051126

§ 371 Date: Jun. 12, 2018

(30) Foreign Application Priority Data
Nov. 19, 2015 (AU) 2015904760

(51) Int. Cl. A62C 3/02; A62C 31/02; A62C 99/00; F23L 7/00

(52) U.S. Cl. CPC A62C 3/0292; A62C 3/0207; F23L 7/005; A62C 99/0018; A62C 31/02

(57) ABSTRACT

The present disclosure relates broadly to a fire control system generally comprising a capture device arranged to capture heat associated with a fire and its by-products, a heat exchanger associated with the capture device for conversion of a working fluid to an expanded working fluid, and a delivery device operatively coupled to the heat exchanger configured to deliver the expanded working fluid to the fire for control of the fire. The fire control system may also be configured so as to draw by-products of the fire into a nozzle, or entrain oxygen through the nozzle, for acceleration through the nozzle and toward the fire.

### PRIORITY CLAIM

This application is a national stage application of PCT/AU2016/051126, filed on Nov. 18, 2016, which claims the benefit of and priority to Australian Patent Application No. 2015904760, filed on Nov. 19, 2015, the entire contents of which are each incorporated by reference herein.

### TECHNICAL FIELD

The present disclosure relates broadly to a fire suppression or fire promotion system. The disclosure also relates to a method of controlling a fire by either suppressing or promoting the fire.

### BACKGROUND

Certain water mist systems are known in the field of fire protection technology and designed to minimise the use of water in suppressing the fire. This is achieved by spraying a pressurised mist of the water into the fire. On impacting the fire, the water mist undergoes a phase change which displaces oxygen from the fire thus suppressing or extinguishing the fire. These water mist systems not only reduce water consumption but also are suited to applications where excess water such as that present in more conventional sprinkler systems cannot be tolerated. They also distinguish from wet chemical systems which on deployment are messy and time consuming to clean up, and may have an adverse impact on the environment. Wet systems also have the inherent problem of causing “water damage” where for example in a library fire, books are more likely to be damaged because they get wet and not because they are burnt.

The known water mist systems also suffer from at least the following drawbacks:
a) they require high pressure pumps or other pressure sources depending on the required pressure at which the mist is to be delivered;
b) they require an independent source of power;
c) in a hybrid mist system, nitrogen or another inert gas is required to reduce the oxygen concentration for effective suppression of the fire;
d) they must be provided with redundancy where for example 2 pumps are required in the event that 1 pump fails.

### SUMMARY

According to a first aspect of the present disclosure there is provided a fire control system comprising:
a heat exchanger adapted to carry a working fluid for expansion to an expanded working fluid on exposure of the heat exchanger to heat;
a delivery device operatively coupled to the heat exchanger for delivery of the expanded working fluid to the fire to control the fire.

According to a second aspect of the disclosure there is provided a method of controlling a fire, said method comprising the steps of:
exposing a working fluid to heat for expansion of the working fluid to an expanded working fluid;
delivering the expanded working fluid to the fire to control the fire.

According to a third aspect of the present disclosure there is provided a fire suppression system comprising:
a capture device for locating at or proximal a fire to capture heat associated with the fire and its by-products;
a heat exchanger adapted to carry water and being associated with the capture device for conversion of the water to wet steam by harnessing the captured heat of the capture device;
a delivery device operatively coupled to the heat exchanger for delivery of the wet steam to the fire for suppression of the fire.

In certain embodiments, the fire suppression system also comprises a nozzle associated with the heat exchanger and configured to draw by-products of the fire into the nozzle for acceleration through the nozzle and toward the fire to promote delivery of the wet steam to the fire for suppression of the fire. In certain of such embodiments, the nozzle includes a jet conduit mounted within the capture device to channel the by-products through the capture device from an inlet of the jet conduit to an outlet of the conduit as an accelerated jet directed toward the fire.

In certain embodiments, the capture device includes a dome-shaped hood and the heat exchanger includes a coil-shaped tube mounted within the hood and adapted to carry the water for conversion to wet steam. In certain of such embodiments, the coil-shaped tube is arranged in concentric circles within the hood, one end of the tube connected to a water supply and an opposite end of the tube associated with the delivery device for delivery of relatively high pressure wet steam to the fire. In further embodiments, the delivery device is surrounded by the jet conduit at or proximal its outlet wherein the accelerated jet of the by-products is promoted by the high pressure steam.

In certain embodiments, the coil-shaped tube is one of a plurality of tubes mounted within the hood. In certain of such embodiments, the nozzle is one of a plurality of nozzles associated with respective of the plurality of tubes.

In certain embodiments, the hood is one of a plurality of dome-shaped hoods connected to one another. In certain of such embodiments, the plurality of hoods are oriented at predetermined angles relative to one another, or moved in operation relative to one another, for effective coverage of the fire at a targeted region at which the fire is to be suppressed.

In certain embodiments, the delivery device is connected to the opposite end of the coil-shaped tube of the heat exchanger. In certain of such embodiments, the delivery device is formed as a restriction in the tube integral with its opposite end. In a variant the delivery device is a spray head connected to the opposite end of the tube, such as an adjustable spray head.

Alternatively the delivery device includes a hose at one end connected to the nozzle and at an opposite end connected to a discharge valve for release of the wet steam and the accelerated jet of the by-products to the fire. In certain embodiments, the delivery device also includes a spray nozzle connected at the opposite end of the hose.

According to a fourth aspect of the disclosure there is provided a method of suppressing a fire, said method comprising the steps of:
capturing heat from a fire and its by-products;
harnessing the captured heat for conversion of water to wet steam;
delivering the wet steam to the fire for suppression of the fire.

In certain embodiments, the method also comprises the step of channelling by-products of the fire toward the fire as an accelerated jet. In certain of such embodiments, the wet steam is delivered to the fire at a relatively high pressure and positioned relative to the accelerated jet of the by-products to promote their delivery to the fire.

It is understood that the wet steam on entering the fire undergoes a phase change which displaces oxygen from the fire thus suppressing the fire. It is also understood that the by-products accelerated toward the fire at relatively high velocity promote penetration of the wet steam into the fire enhancing its action in suppressing the fire. It is further understood that the accelerated by-products, and in particular carbon dioxide, displaces oxygen from the fire thus suppressing the fire. It is still further understood that the wet steam has a cooling effect in suppressing the fire.

It is to be understood that wet steam includes saturated steam in the two-phase region of the steam tables.

According to a fifth aspect of the disclosure there is provided a fire promotion system comprising:
a capture device for locating at or proximal a fire to capture heat associated with the fire and its by-products;
a heat exchanger adapted to carry water and being associated with the capture device for conversion of the water to substantially dry steam by harnessing the captured heat of the capture device;
a delivery device operatively coupled to the heat exchanger for delivery of the substantially dry steam toward the fire for promotion of the fire

In certain embodiments, the fire promotion system also comprises a nozzle associated with the heat exchanger wherein the substantially dry steam is entrained with oxygen and directed toward the fire which is promoted by the entrained oxygen. In certain of such embodiments, the nozzle includes a jet conduit mounted within the capture device to promote the delivery of the oxygen-entrained steam toward the fire as an accelerated jet which also forces at least some of the by-products of the fire away from the fire, thus together acting to promote the fire.

In certain embodiments, the capture device includes a dome-shaped hood and the heat exchanger includes a coil-shaped tube mounted within the hood and adapted to carry the water for conversion to substantially dry steam. In certain of such embodiments, the coil-shaped tube is arranged in concentric circles within the hood, one end of the tube connected to a water supply and an opposite end of the tube associated with the delivery device for delivery of relatively high pressure dry steam to the fire. In further embodiments, the delivery device is surrounded by the jet conduit to enhance the accelerated jet of the oxygen-entrained steam.

According to a sixth aspect of the disclosure there is provided a method of promoting a fire, said method comprising the steps of:
capturing heat from a fire and its by-products;
harnessing the captured heat for conversion of water to substantially dry steam;
delivering the substantially dry steam toward the fire for promotion of the fire.

In certain embodiments, the method also comprises the step of entraining the steam with oxygen and directing the oxygen-entrained steam toward the fire to promote the fire. In certain of such embodiments, the oxygen-entrained steam is directed toward the fire as an accelerated jet which forces at least some of the by-products of the fire away from the fire, thus acting to promote the fire.

It is to be understood that substantially dry steam includes superheated steam at a temperature greater than its saturation temperature.

According to a seventh aspect of the disclosure there is provided a fire suppression system comprising:
a capture device for locating at or proximal a fire to capture heat associated with the fire and its by-products;
a heat exchanger adapted to carry a working fluid and being associated with the capture device for expansion of the working fluid to an expanded working fluid by harnessing the captured heat of the capture device;
a delivery device operatively coupled to the heat exchanger for delivery of the expanded working fluid to the fire for suppression of the fire.

According to an eighth aspect of the disclosure there is provided a method of suppressing a fire, said method comprising the steps of:
capturing heat from a fire and its by-products;
harnessing the captured heat for expansion of a working fluid to an expanded working fluid;
delivering the expanded working fluid toward the fire for suppression of the fire.

According to a ninth aspect of the disclosure there is provided a fire promotion system comprising:
a capture device for locating at or proximal a fire to capture heat associated with the fire and its by-products;
a heat exchanger adapted to carry a working fluid and being associated with the capture device for expansion of the working fluid to an expanded working fluid by harnessing the captured heat of the capture device;
a delivery device operatively coupled to the heat exchanger for delivery of the expanded working fluid toward the fire for promotion of the fire.

According to a tenth aspect of the disclosure there is provided a method of promoting a fire, said method comprising the steps of:
capturing heat from a fire and its by-products;
harnessing the captured heat for expansion of a working fluid to an expanded working fluid;
delivering the expanded working fluid toward the fire for promotion of the fire.

According to an eleventh aspect of the disclosure there is provided a fire control system comprising:
a capture device for locating at or proximal a fire to capture heat associated with the fire and its by-products;
a heat exchanger adapted to carry a working fluid and being associated with the capture device for expansion of the working fluid to an expanded working fluid by harnessing the captured heat of the capture device;
a delivery device operatively coupled to the heat exchanger for delivery of the expanded working fluid toward the fire for suppression or promotion of the fire.

According to a twelfth aspect of the disclosure there is provided a method of controlling a fire, said method comprising the steps of:
capturing heat from a fire and its by-products; harnessing the captured heat for expansion of a working fluid to an expanded working fluid;
delivering the expanded working fluid toward the fire for suppression or promotion of the fire.

It is to be understood that fire includes a fire plume and its associated by-products including but not limited to heat, carbon dioxide, smoke, unburnt fuel/ash, and combustion gases.

Additional features and advantages are described in, and will be apparent from the following Detailed Description and the figures.

### BRIEF DESCRIPTION OF DRAWINGS

In order to achieve a better understanding of the nature of the present disclosure, an example embodiment of a fire suppression or fire promotion system will now be described, by way of example only, with reference to the accompanying drawings in which:

FIG. 1 is a lower perspective view of a fire suppression system according to one embodiment of the disclosure;

FIG. 2 is an underneath plan view of the fire suppression system of the embodiment of FIG. 1;

FIG. 3 is a side elevational view of the fire suppression system of the embodiment of FIGS. 1 and 2;

FIG. 4 is a sectional view taken from the embodiment of FIG. 2 of the fire suppression system;

FIGS. 5a and 5b are schematic side views of the fire suppression system of the preceding embodiment in operation;

FIG. 6 is a lower perspective view of another embodiment of a fire suppression system according to the disclosure;

FIG. 7 is an upper perspective view of a further embodiment of a fire suppression system according to the disclosure;

FIG. 8 is a lower perspective view of the fire suppression system of the embodiment of FIG. 7;

FIG. 9 is a schematic illustration of yet another embodiment of a fire suppression system according to the disclosure; and

FIG. 10 is a schematic illustration of yet a further embodiment of a fire suppression system according to the disclosure.

### DETAILED DESCRIPTION

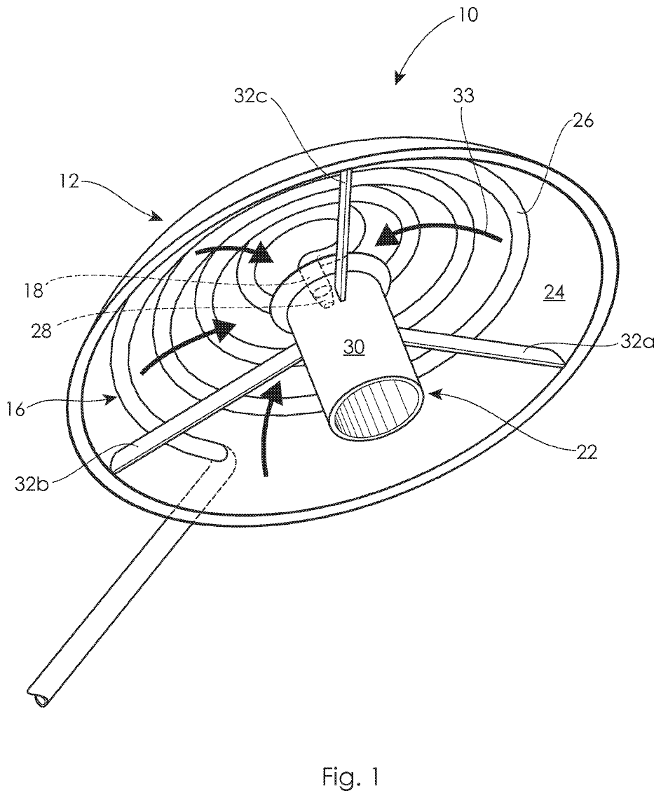

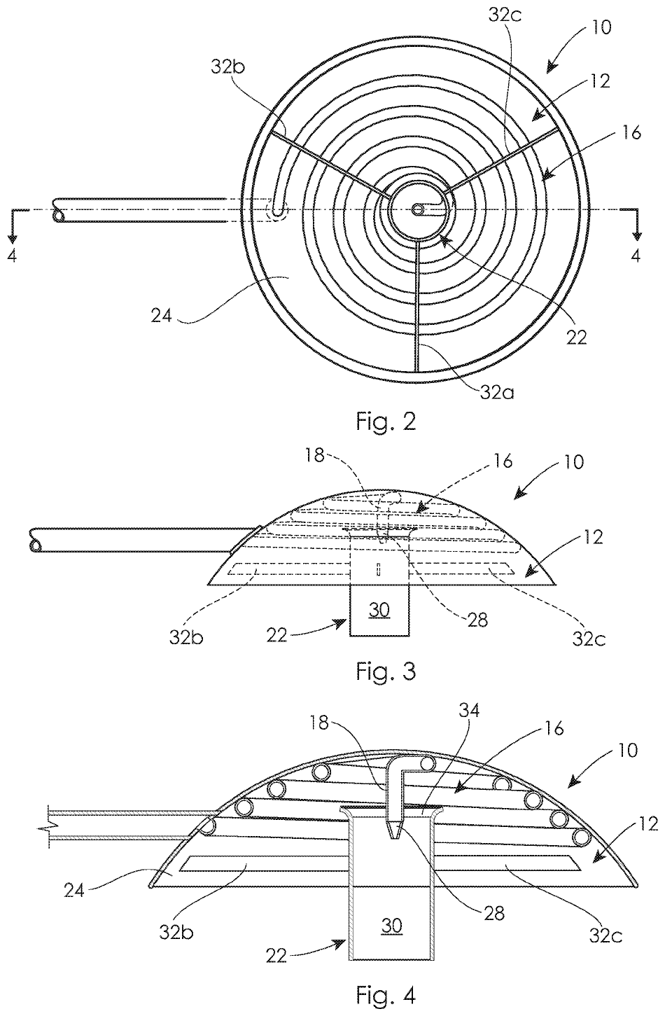

As shown in FIGS. 1 to 5 there is one embodiment of a fire suppression system 10 constructed in accordance with one aspect of the disclosure. The fire suppression system 10 generally comprises a capture device 12 arranged to capture heat associated with a fire such as 14 and its by-products, a heat exchanger 16 associated with the capture device 12 for expansion of a working fluid to an expanded working fluid, and a delivery device 18 operatively coupled to the heat exchanger 16 for delivering the expanded working fluid 20 to the fire 14 for its suppression. In this embodiment the fire suppression system 10 also comprises a nozzle 22 associated with the capture device 12 and configured to draw by-products of the fire 14 into the nozzle 22 for acceleration through the nozzle 22 and toward the fire 14.

In the described embodiments the working fluid is water and the heat exchanger 16 converts the water to wet steam. It should be appreciated that other working fluids may be appropriate including but not limited to other liquids, liquid/vapour mixtures (wet vapour), dry vapour (saturated or superheated), or solids which may decompose or sublime to form a gas. Hydrofluorocarbons, carbon dioxide and inert gases are examples of alternative working fluids. In all examples of working fluids the heat captured by the working fluid causes the working fluid to expand (or convert) wherein the working fluid has a higher proportion of vapour to liquid or greater degree of superheat which is evidenced by an increase in its specific volume (volume per unit mass).

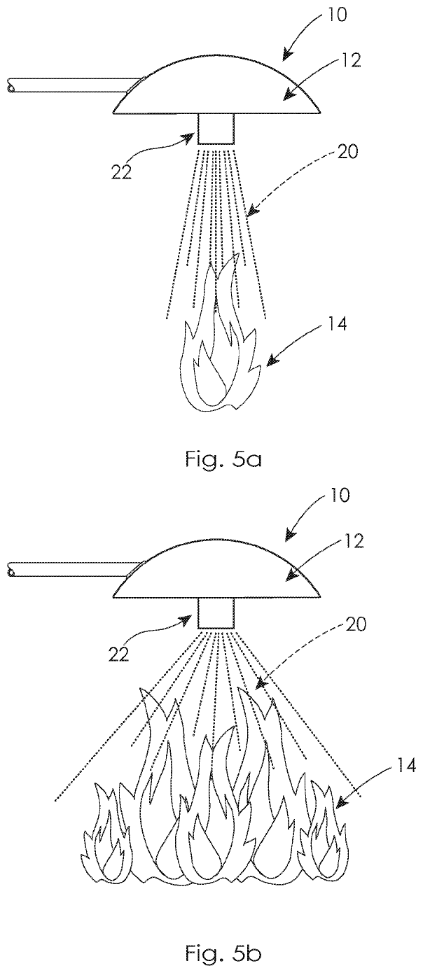

In this example the capture device 12 includes a dome-shaped hood 24 and the heat exchanger 16 includes a coil-shaped tube 26 mounted within the hood 24 and adapted to carry water for its conversion to wet steam. The coil-shaped tube 26 is arranged in concentric circles within the hood 24. One end of the tube 26 adjacent a perimeter of the dome 24 is connected to a water supply (not shown) and an opposite end of the tube 26 is associated with the delivery device 18 at a central axis of the dome 24. The coil-shaped tube 26 of this example is in contact with the dome 24 for efficient heat transfer and thus is shaped in the form of a helix of decreasing diameter. The delivery device 18 is in this embodiment formed integral with the coil-shaped tube 26 in the form of a tapered nozzle 28. In an alternative embodiment the delivery device may be in the form of a spray head (not shown) connected to the discharge end of the coil-shaped tube 26. The spray head may be adjustable to vary the coverage of the wet steam such as 20 delivered to the fire 14, see FIGS. 5a and 5b for narrow and wide spray head settings.

In this embodiment the nozzle 22 is in the form of a jet conduit 30 mounted at the central axis of the dome 24 via radial mounting arms such as 32a to 32c connected at their radial extremities to the inner perimeter region of the dome-shaped hood 24. The jet conduit 30 is axially spaced from a ceiling of the hood 24 to allow the ingress of by-products of the fire into the nozzle 22, schematically shown by flowlines with solid arrowheads 33 in FIG. 1. The jet conduit 30 at or adjacent its inlet 34 surrounds the tapered nozzle 28 of the delivery device 18 wherein high pressure steam exiting the tapered nozzle 28 assists in acceleration of the by-products through the nozzle 22. The dome 24 effectively traps the by-products of the fire and channels them toward the inlet or entrance 34 of the nozzle 22 although without the dome 24 the nozzle 22 will still draw some of the by-products into its entrance 34.

It is expected that the steam pressure at the tapered nozzle 28 will be at around 10 to 100 times atmospheric pressure. The pressurised steam when discharged from the nozzle 28 to atmosphere thus undergoes a significant pressure drop. It is understood that this pressure differential or “delta P” is a driving force in assisting with or promoting acceleration of the by-products through the nozzle 22. This may be supplemented by the action of a turbine or propeller fitted to the system to increase the velocity of the jet of the by-products directed to the fire. The turbine or propeller is typically driven for rotation by the by-products themselves being drawn into and through the nozzle of the system.

In operation the fire suppression system 10 of the preceding embodiment broadly functions as follows:
1. the capture device 12 is located at or proximal a fire to capture heat and by-products associated with the fire;
2. the heat exchanger 16 associated with the capture device 12 carries a relatively small volume of water which is converted to wet steam harnessing the captured heat of the capture device 12;
3. the wet steam is delivered to the fire via the delivery device 18 for suppression of the fire such as 14.

In this example the by-products of the fire 14 are channelled via the capture device 12 and nozzle 22 toward the fire 14 as an accelerated jet. It is understood that the accelerated jet of the by-products promotes penetration of the wet steam into the fire enhancing its action in suppressing the fire 14. The high pressure wet steam may otherwise fall short of the fire, or more importantly the fire plume, in which case the phase change in the wet steam would occur remote from the fire and thus be less effective in displacing oxygen from the fire and suppressing the fire. It is understood that when the local concentration of oxygen at the fire falls below 10% the fire is suppressed (i.e., minus that component of the fire triangle). In addition to suppression of the fire by a phase change in the wet steam at the fire plume, it is understood that suppression of fire in various embodiments of the disclosure is assisted by:
1. the accelerated by-products, and in particular carbon dioxide, which displaces oxygen from the fire;
2. the wet steam which has a cooling effect in suppressing the fire.

In any event the fire suppression system such as 10 should be operated at conditions which produce wet steam which is to be understood as saturated steam in the two-phase region of the steam tables. The following operating conditions may influence and control the production of wet steam in the fire suppression system:
1. the temperature at which the heat exchanger operates;
2. the pressure at which the wet steam is released from the delivery device;
3. the location of the capture device relative to the fire and more particularly its distance from the fire plume.

Unlike the prior art, it is possible to control the water content of the wet steam and thus the degree to which it will suppress the fire. This is because the water content dictates the extent of energy in the phase change “reaction” and displacement of oxygen on exposing the wet steam to the fire and its associated plume. The water content of the wet steam may be controlled by the particular construction including materials selection of the system itself or in a more sophisticated design may include pressure and/or temperature transducers arranged to control the degree of saturation of the wet steam. The system may include a pressure relief valve to ensure the wet steam does not reach its saturation temperature wherein its negligible water content lessens its effect in fire suppression.

In a prototype version of the fire suppression system the capture device 12 or dome-shaped hood 24 is approximately 20 cm in diameter. The coil-shaped tube 26 of the heat exchanger 16 is around 50 cm in length and has an internal diameter of around 5 mm. Under experimental conditions the prototype suppression system was operated with a water supply at around 600 kPa and a flow rate of around 18 ml/min. The system was observed to suppress or extinguish a relatively small spot fire in less than around 15 seconds consuming less than 5 ml of water. The prototype was manually waved over the spot fire for adequate coverage in suppressing the fire.

It will be appreciated that this prototype construction of the system and the process conditions under which it was operated are merely illustrative of the disclosure and its possible other embodiments. Having said that, it should be noted that the system was effective in suppressing the fire with limited water consumption, harnessing the fire and its by-products to produce the requisite wet steam for fire suppression. The prototype system will be scaled in its constructional size and operating conditions in order to suit its particular application in fire suppression.

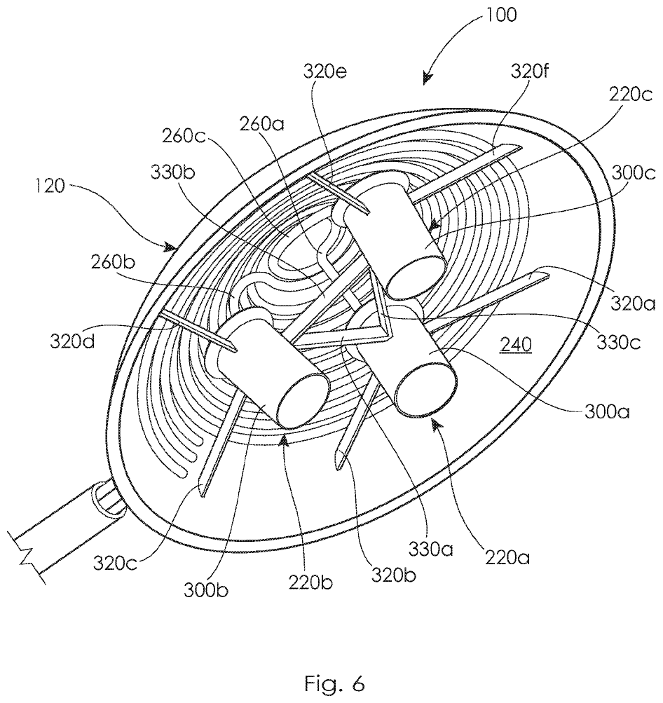

FIG. 6 illustrates another embodiment of a fire suppression system 100 with multiple nozzles such as 220a to 220c associated with a common capture device 120. For ease of reference and in order to avoid repetition, like components of this embodiment have been indicated with the same reference numeral as the preceding embodiment but with an additional “0”. In this other embodiment each of the nozzles such as 220 to 220c is dedicated to respective of a plurality of coil-shaped tubes 260a to 260c mounted within the dome-shaped hood 240. The nozzles such as 220a are mounted to the hood 240 via radial mount arms such as 320a and 320b, and interconnected centrally via interconnecting arms 330a to 330c. The fire suppression system 100 is otherwise of similar construction to the preceding embodiment.

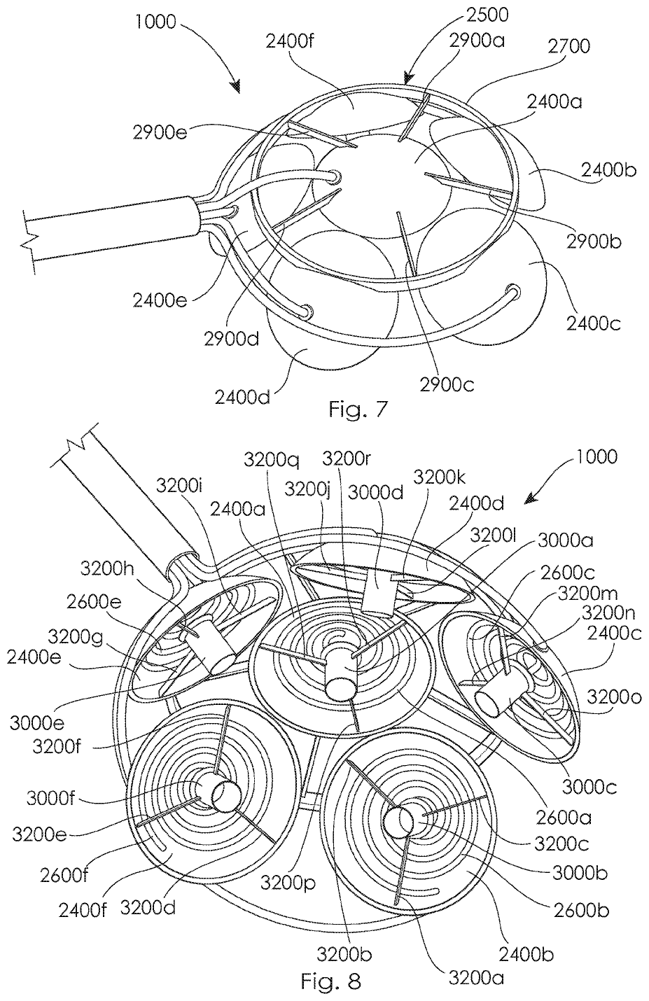

FIGS. 7 and 8 are perspective views of a further embodiment of a fire suppression system 1000 according to the disclosure. For ease of reference and in order to avoid repetition, like components of this embodiment have been indicated with the same reference numeral as the preceding embodiment but with an additional “00”. In this variation the system 1000 includes a plurality of dome-shaped hoods 2400a to 2400f of substantially identical construction to the preceding embodiment of FIGS. 1 to 5. In this further embodiment the system 1000 includes a framework 2500 including an outer ring member 2700 interconnecting the five outer hoods 2400b to 2400f, and five support spokes such as 2900a extending inwardly from the outer ring 2700 to the central hood 2400a.

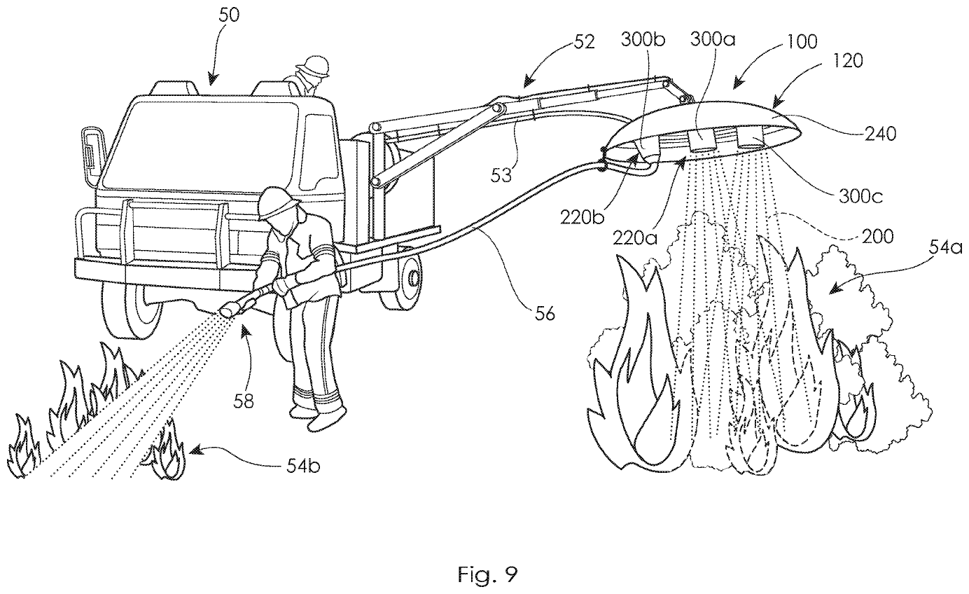

FIG. 9 illustrates yet another embodiment of the fire suppression system in this case deployed from a fire fighting vehicle such as 50. The system 100 is otherwise substantially the same as the preceding embodiment of FIG. 6 but with the hood 24 and its associated components suspended from a telescopic arm or boom 52 connected to the fire fighting vehicle 50. The vehicle 50 includes a small volume of water for supply to the heat exchangers via supply hose 53 for conversion to wet steam. The saturation pressure of the steam of this embodiment is set by the discharge pressure of the water pump associated with the vehicle 50. It can be seen that in addition to harnessing the heat and other by-products of the fire for suppression at location 54a the fire at location 54b can also be suppressed using this variation on the system.

In the embodiment of FIG. 9, the delivery device includes a hose 56 operatively coupled at one end to the nozzle 220b and at an opposite and remote end connected to a discharge valve 58. The hose 56 is in this example flexible and thus can be manipulated by a person operating the discharge valve 48 in fighting the fire at the other location 54b. This discharge valve 58 is in the form of a spray nozzle and discharges wet steam onto the fire 54b for its suppression in a similar manner to the other delivery nozzles such as 220a associated with the dome-shaped hood 240. In a variation on this embodiment, the system may not include a capture device or hood in which case the heat exchanger is located at the fire fighting vehicle 50. The heat exchanger is heated via an independent heat source at the vehicle 50 in order to expand a working fluid carried by the heat exchanger into an expanded working fluid, such as wet steam, for discharge onto the fire via the hose 56 and its associated spray nozzle 58. In this configuration, the system need not include the telescopic arm or boom 52 and the hose 56 may run directly off the vehicle 50. The independent heat source may be in the form of a furnace or oven mounted to the vehicle 50, and the working fluid may in part be heated by the radiator of the vehicle 50.

The system may be deployed in other mobile applications for fire control. For example the system may be fitted to a drone or other airborne vehicle. It is possible that propulsion of the drone may be assisted by the action of the accelerated jet of the by-products discharged from the system. The drone may be remotely navigated across the fire to suppress the fire at strategic locations. In mobile applications including small scale handheld systems, the system is typically designed to be swept across the fire region to suppress the fire in a gradual manner, generally commencing at or near the periphery of the fire system.

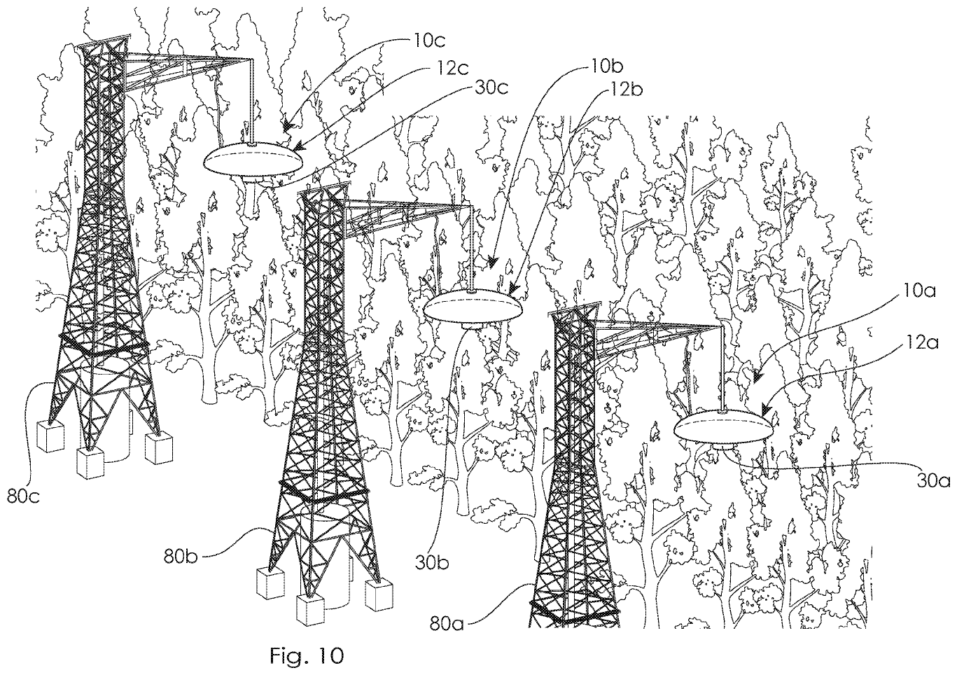

FIG. 10 illustrates yet a further embodiment of the fire suppression system which may be strategically located on each of a series of towers such as 80a to 80c at a boundary to a built-up area. In this application the system effectively functions as a fire break in preventing travel of fire front to the built-up areas. In this further embodiment each of the fire suppression systems such as 10a is suspended or hung from its respective tower such as 80a and is of substantially similar construction to the preceding embodiment of FIGS. 1 to 5. Each of the towers such as 80a may include a rainwater capture tank (not shown) connected to the heat exchanger such as 16a for a gravity-fed supply of water for conversion to wet steam. The delivery device at the discharge of the coiled tube may be temporarily blocked with a metal plug or other material having a low melting point. In operation, the lower melting point material is melted by the heat of the fire to permit the subsequent deliver of wet steam to the fire.

In another aspect the disclosure is directed to a fire promotion system and method of promoting a fire which may for example increase the rate of the fire depending on the particular application. It is to be understood that fire promotion includes but is not limited to:
1. creating a condition (or set of conditions) where a fire is allowed to burn in circumstances where it would not otherwise have been possible to ignite the fire or where it would not otherwise have been possible for the fire to continue to burn, provided pre-existing heat is present to facilitate expansion of the working fluid to the extent needed to enable the system to function;
2. accelerating the rate of combustion in terms of consumption of fuel per unit time, output of heat per unit of fuel, consumption of fuel and/or oxygen per unit, or output of heat per unit time;
3. improving the quality of the combustion, for example, by reducing the component of carbon monoxide or unburnt fuel in the by-product;
4. increasing the pressure of a flame associated with the fire wherein it travels further or overcomes obstacles;
5. providing a mechanism to optimise the supply of oxygen to the fire and/or the extraction of by-products so as to achieve the other forms of fire promotion described.

The fire promotion system is of similar construction to the fire suppression system of the preceding aspect except it delivers substantially dry steam to the fire. It will be appreciated that other working fluids, instead of or in addition to water, may be used for fire promotion. In addition to the alternative forms of working fluids disclosed in the context of fire suppression, fuel or accelerants may be carried within the heat exchanger where for example the fuel is a liquid fuel harnessed or extracted from the source of the fire itself

It is understood that oxygen (typically entrained in air) is entrained in the flow of gas drawn into the nozzle such as 30 under the influence of the steam injected through the nozzle 30 in the form of a jet. This action of drawing the oxygen-entrained gas into and through the nozzle 30 is promoted by the venturi effect caused by the jet of high pressure steam acting through the nozzle 30 at or adjacent its entrance. The oxygen-entrained steam is delivered to the fire as part of the accelerated jet of high pressure steam and the oxygen promotes or accelerates the fire. The accelerated jet also forces some of the by-products of the fire away from the fire serving to further promote combustion of the fire. The system thus promotes the fire in two ways either independent of each other or simultaneously. The greater kinetic energy and specific volume of the steam or other expanded fluid exiting the delivery device acts as the driving force in forcing oxygen into the reaction and forcing by-products out.

In comparison to the experimental operating conditions for the prototype of the fire suppression system of the preceding aspect of the disclosure, it will be understood that this aspect of the technology for promotion of the fire is controlled by:
1. capturing additional heat from the fire by for example locating the capture device at closer proximity to the fire plume;
2. increasing the temperature of the working fluid in the heat exchanger by for example reducing the flow rate through the heat exchanger or redesigning the heat exchanger to increase its exposed surface area to the heat of the fire and its associated by-products;
3. adjusting the pressure of the working fluid by for example increasing the back pressure induced by the delivery device.

In a prototype version of the fire promotion system the capture device or dome-shaped hood and the associated components are the same as the described prototype of the suppression system. Under experimental conditions the prototype promotion system was operated with a water supply at around 600 kPa and a flow rate of around 8 ml/min. The system was observed to promote both a relatively small spot fire and a hydrocarbon (methylated spirits) based fire whenever the jet of steam was deployed over the fire. In a likely variation on this prototype design the dome-shaped hood may be inverted to minimise or lessen the obstruction the hood presents to the flame associated with the fire whilst still providing an effective heat exchange area. On a larger scale, the fire promotion system may be used to finish a back-burn or firebreak quickly before the wind direction changes. In another application the fire promotion system may be used to further inflame a flare stack in for example a petrochemical plant to minimise the discharge of unburnt greenhouse-damaging gases. The additional heat energy generated by the fire promotion system may be recovered by the petrochemical plant.

In its fire promotion mode the system may entrain fuel in addition to oxygen to promote combustion. This may be a requirement where there is excess oxygen at the fire demanding a greater quantity of fuel into the reaction. The fuel may be in a liquid form and thus forced into the fire to complement the excess oxygen for its complete consumption at the fire. It should be noted that this may serve as a non-mechanical alternative to a fuel pump which would otherwise require external power to drive it.

It will also be apparent to a person skilled in the art that the fire control system can be operated in order to selectively suppress or promote the fire depending on the circumstances. This control may be effected by controlling the pressure and/or temperature of the steam or other expanded working fluid which enables both) the consumption of the working fluid by the system to be reduced potentially to minute or trace volumes, and ii) switching of the device or system between a fire suppression mode and a fire promotion mode. Alternatively, the efficiency of control of the fire may be controlled by the pressure/temperature of the expanded working fluid, for example increased pressure/temperature at the same rate of working fluid consumption will speed up control of the fire. This control of the system involves capturing heat from the fire and its by-products and then harnessing the captured heat for conversion of water or other working fluid to either:
1. wet steam, or other expanded working fluid, for delivery to the fire for suppression of the fire; or
2. substantially dry steam, or other expanded working fluid, for delivery to the fire for promotion of the fire.

It is expected that the same system or device will be used in implementation of this method for selectively controlling the fire. In this instance the system can be changed or switched from one mode, (such as fire suppression) to another mode (such as fire promotion) by either:
1. manually changing operation of the system; or
2. automatically adjusting the output of the system, typically either wet steam or substantially dry steam, based on feedback from sensors, such as pressure and/or temperature transducers associated with the system.

The system may thus cycle between the two modes, suppression and promotion, depending on the requirement. For example, the system, may switch to a fire promotion mode in order to “charge” the system with additional heat energy adequate for a subsequent switch to a fire suppression mode.

It will be appreciated by persons skilled in the art that although in this embodiment wet steam is optimal in fire suppression and substantially dry steam preferable in fire promotion other factors may contribute to the mode in which the system operates. The other factors include but are not limited to relative positioning of the system and its associated jet, the speed and direction of the steam or other expanded fluid, the relative concentrations of the mixture of gases at or in proximity to the fire (including the concentration of oxygen which can be controlled/injected using the system), the direction in which the fire influenced by the system (suppressed or promoted) is driven, and which aspect of the fire system is influenced including the fire plume itself, the fuel, or the surrounding atmosphere.

It will be understood that heat captured from the fire and its by-products includes but is not limited to:
1. radiation from light produced by flames associated with the fire;
2. direct contact or convection with flames associated with the fire;
3. direct contact or convection with by-products of flames associated with the fire to harness the heat of the by-products.

Now that several embodiments of the disclosure have been described it will be apparent to those skilled in the art that the fire control system has at least the following advantages over the admitted prior art:
1. the system harnesses the energy and by-products of the fire itself in order to control it;
2. the fire system relies solely on a working fluid, typically in relatively small volumes, in the production of an expanded working fluid to control the fire;
3. the fire system can be controlled by controlling the degree of expansion of the working fluid which to a large extent controls the displacement from or induction of oxygen to the fire plume;
4. the system is relatively simple in its construction, typically having no moving parts.

Those skilled in the art will appreciate that the disclosure described herein is susceptible to variations and modifications other than those specifically described. The system is not to be limited to the applications described but lends itself to suppressing indoor fires and is not to be limited to the outdoor applications explicitly disclosed. For example, the system may extend to ceiling or roof mounted units which substitute for or can be retrofitted to conventional sprinkler systems. In this case the system may be interfaced with sensing and monitoring devices for control purposes. The system may also have application in controlling or suppressing kitchen oven or cooktop fires which contribute to a large percentage of domestic fires. In this application the rangehood associated with the oven or cooktop may be retrofitted with one or more of the described embodiments or alternatively the canopy of the rangehood itself may form part of the capture device or hood of the disclosure. In terms of construction the system is not limited to the dome-shaped hood but rather includes other shaped devices configured to capture the heat and associated by-products of the fire.

In its broadest sense the system may not include a capture device in which case the heat exchanger is exposed to heat for expansion of the associated working fluid to an expanded fluid which is thereafter delivered to the fire. The heat exchanger is not limited to the tubular arrangement described but rather extends to any other form of heat exchanger which can effectively harness the energy of the fire and its by-products for expansion of the working fluid into an expanded working fluid, such as steam. Without a capture device, the heat exchanger itself may be located or immersed within the fire. In an alternative design, the heat exchanger may be heated independent of the fire which is being controlled by the system. This independent heating may supplement the heat the system otherwise harnesses from the fire itself, or may entirely substitute for the heat of the fire.

All such variations and modifications are to be considered within the scope of the present disclosure the nature of which is to be determined from the foregoing description. Thus, while there has been described what are believed to be the various embodiments of the disclosure, those skilled in the art will recognize that other and further modifications may be made thereto without departing from the spirit of the disclosure, and it is intended to claim all such changes and modifications as falling within the scope of the disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The invention is claimed as follows:

1-33. (canceled)

34. A fire suppression system comprising:
a capture device configured to be located at or proximal to a fire to capture heat associated with the fire and by-products of the fire;
a heat exchanger associated with the capture device and configured to carry water and convert the water to wet steam by harnessing the captured heat of the capture device; and
a delivery device operatively coupled to the heat exchanger and configured to suppress the fire via delivering the wet steam to the fire.

35. The fire suppression system of claim 34, further comprising a nozzle associated with the heat exchanger and configured to draw the by-products of the fire into the nozzle for acceleration through the nozzle and toward the fire to promote delivery of the wet steam to the fire.

36. The fire suppression system of claim 35, wherein the nozzle includes a jet conduit mounted within the capture device to channel the by-products of the fire through the capture device from an inlet of the jet conduit to an outlet of the jet conduit as an accelerated jet directed toward the fire.

37. The fire suppression system of claim 36, wherein the capture device includes a dome-shaped hood and the heat exchanger includes a coil-shaped tube mounted within the hood and configured to carry the water for conversion to wet steam.

38. The fire suppression system of claim 37, wherein the coil-shaped tube is arranged in concentric circles within the hood, one end of the tube connected to a water supply and an opposite end of the tube associated with the delivery device configured to deliver relatively high pressure wet steam to the fire.

39. The fire suppression system of claim 36, wherein the delivery device is surrounded by the jet conduit at or proximal the outlet of the jet conduit such that the accelerated jet of the by-products of the fire is promoted by the high pressure steam.

40. The fire suppression system of claim 37, wherein the delivery device is connected to the opposite end of the coil-shaped tube of the heat exchanger.

41. The fire suppression system of claim 40, wherein the delivery device is formed as a restriction in the tube integral with its opposite end.

42. The fire suppression system of claim 40, wherein the delivery device is a spray head connected to the opposite end of the tube.

43. The fire suppression system of claim 35, wherein the delivery device includes a hose at one end connected to the nozzle and at an opposite end connected to a discharge valve configured to release the wet steam and the accelerated jet of the by-products to the fire.

44. The fire suppression system of claim 43, wherein the delivery device further includes a spray nozzle connect at the opposite end of the hose.

45. A method of suppressing a fire, said method comprising:
capturing heat from a fire and by-products of the fire;
harnessing the captured heat for conversion of water to wet steam; and
suppressing the fire via delivering the wet steam to the fire.

46. The method of claim 45, further comprising channelling by-products of the fire toward the fire as an accelerated jet.

47. The method of claim 46, wherein the wet steam is delivered to the fire at a relatively high pressure and positioned relative to the accelerated jet of the by-products to promote their delivery to the fire.

48. A fire promotion system comprising:
a capture device configured to be located at or proximal to a fire to capture heat associated with the fire and by-products of the fire;
a heat exchanger associated with the capture device and configured to carry water and convert the water to substantially dry steam by harnessing the captured heat of the capture device; and
a delivery device operatively coupled to the heat exchanger and configured to promote the fire via delivering the substantially dry steam toward the fire.

49. The fire promotion system of claim 48, further comprising a nozzle associated with the heat exchanger and configured to draw by-products of the fire into the nozzle for acceleration through the nozzle and toward the fire to promote delivery of the substantially dry steam to the fire.

50. The fire promotion system of claim 49, wherein the nozzle includes a jet conduit mounted with the capture device to channel the by-products of the fire through the capture device from an inlet of the jet conduit to an outlet of the jet conduit as an accelerated jet directed toward the fire.

51. The fire promotion system of claim 50, wherein the capture device includes a dome-shaped hood and the heat exchanger includes a coil-shaped tube mounted within the hood and configured to carry the water for conversion to substantially dry steam.

52. The fire promotion system of claim 51, wherein the coil-shaped tube is arranged in concentric circles within the hood, one end of the tube connected to a water supply and an opposite end of the tube associated with the delivery device configured to deliver relatively high pressure dry steam to the fire.

53. The fire promotion system of claim 51, wherein the delivery device is surrounded by the jet conduit at or proximal the outlet of the jet conduit such that the accelerated jet of the by-products of the fire is promoted by the high pressure steam.
